(19) United States
(12) Patent Application Publication
(10) Pub. No.: US 2021/0309780 A1
(43) Pub. Date: Oct. 7, 2021

(54) METHYLENE MALONATE MONOMERS AND MULTIFUNCTIONAL MACROMERS AS ADDITIVES DURING PLASTICS PROCESSING

(71) Applicant: Sirrus, Inc., Loveland, OH (US)

(72) Inventors: Deenadayalu Chundury, Loveland, OH (US); Aniruddha Palsule, Cincinnati, OH (US)

(21) Appl. No.: 17/223,793

(22) Filed: Apr. 6, 2021

Related U.S. Application Data
(60) Provisional application No. 63/006,123, filed on Apr. 7, 2020.

(51) Int. Cl. C08F 283/06; C08F 283/02

(52) U.S. Cl. CPC C08F 283/06; C08F 283/02

(57) ABSTRACT

Disclosed are compositions which include a polymer with a nucleophilic group and a 1,1-disubstituted alkene disposed on the polymer. Disclosed is a composition containing a polymer which includes a nucleophilic group. In addition, also disclosed are methods of making a composition including a polymer with a nucleophilic group and a 1,1-disubstituted alkene disposed on the polymer, methods of chain extending or cross linking a polymer with a nucleophilic group with a 1,1-disubstituted alkene and methods of polymerizing a 1,1-disubstituted alkene.

### FIELD

The present application claims the priority of U.S. provisional patent application Ser. No. 63/006,123, filed Apr. 7, 2020, and hereby incorporates the same application herein by reference in its entirety.

Disclosed are compositions which include a polymer with a nucleophilic group and a 1,1-disubstituted alkene disposed on the polymer. Disclosed is a composition containing a polymer which includes a nucleophilic group. In addition, also disclosed are methods of making a composition including a polymer with a nucleophilic group and a 1,1-disubstituted alkene disposed on the polymer, methods of chain extending or cross linking a polymer with a nucleophilic group with a 1,1-disubstituted alkene and methods of polymerizing a 1,1-disubstituted alkene.

### BACKGROUND

1,1-dicarbonyl-1-alkenes are increasingly important monomers in forming a variety of compounds and polymerizable compositions because of inherent ability to rapidly polymerize at ambient temperatures upon contact with basic materials. 1,1-dicarbonyl-1-alkenes include methylene malonates, methylene dimalonamides, methylene keto malonamides, methylene diketones, methylene keto esters, and the like. Such compounds have been known since 1886 where the formation of diethyl methylene malonate was first demonstrated by W. H. Perkin, Jr. (Perkin, Ber. 19, 1053 (1886)). Early methods for synthesizing methylene malonates suffered from significant deficiencies that precluded preparing commercially viable monomers, (e.g., unwanted polymerization of the monomers during synthesis (e.g., formation of polymers or oligomers or alternative complexes), formation of undesirable side products (e.g., ketals or other latent acid-forming species which impede rapid polymerization)), degradation of the product, insufficient and/or low yields, and ineffective and/or poorly functioning monomer product (e.g., poor adhesive characteristics, stability, or other functional characteristics), among other problems. The overall poor yield, quality, and chemical performance of the monomers formed by prior methods prevented their practical use in the production of commercial products.

In recent years a number of commonly owned patent applications have been filed which have solved a number of the problems associated with the synthesis of methylene malonates and analogs thereof, for example, Malofsky et al., U.S. Pat. No. 8,609,885, Malofsky, U.S. Pat. No. 8,888,051, Malofsky et al., U.S. Pat. No. 9,108,914 and Sullivan et al., U.S. Pat. No. 9,518,001. The synthesis procedures described therein resulted in improved yields of heretofore elusive, high quality 1,1-dicarbonyl-1-alkenes.

The availability of high quality 1,1-dicarbonyl-1-alkenes has led to their use in bulk polymerization processes, which typically operate at or near ambient temperature and can be initiated with a wide number of reagents. More recently, solution polymerization processes, emulsion polymerization processes, and water based polymerization processes, which utilize high quality 1,1-dicarbonyl-1-alkenes have been recently developed (e.g., Stevenson et al., U.S. Pat. Nos. 9,249,265, 10,081,605) and new application of these polymers have emerged.

However, initiation of 1,1-dicarbonyl-1-alkene polymerization using nucleophilic groups disposed on polymer surfaces in melts has not yet been explored. Herein melts means that any crystalline polymer melts and if the polymer is amorphous the temperature is above the glass transition temperature and the polymer flows sufficiently to be melt processed as typical in the art using common mixing or compounding extruders. Crosslinking and chain extension of 1,1-dicarbonyl alkenes using nucleophilic groups of a polymer in melts may enhance mechanical properties and aesthetic properties of the initiating polymer without using undesirable additive such, as for example, phosphites, titanates, zirconates, isocyanates, etc.

Accordingly, what is needed are new methods for initiating 1,1-dicarbonyl-1-alkene polymerization using nucleophilic groups on polymer surfaces in melts.

### SUMMARY

It has been discovered that the methods of the invention facilitate to provide polymers with improved mechanical properties and aesthetic properties without the inclusion of conventional additives. In particular, the methods facilitate the recycling of used or recycled polymers that may have been degraded due to their use or exposure to the environment (UV, thermal, oxidation and the like).

Disclosed herein are methods and compositions which satisfy these and other needs. Disclosed are compositions which include a polymer with a nucleophilic group and a 1,1-disubstituted alkene disposed on the polymer. The 1,1 dicarbonyl 1-alkene may correspond to the formula:

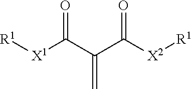

where X¹ and X² separately in each occurrence are an oxygen atom, a direct bond or —NR²; and R¹ and R² separately in each occurrence are hydrocarbyl groups, which are optionally substituted, that are the same or different.

Disclosed is a method of making a composition which includes the steps of mixing the polymer which includes a nucleophilic group and the 1,1-disubstituted alkene

Disclosed is a method of chain extending or cross linking a polymer with a nucleophilic group with a 1,1-disubstituted alkene including the steps of melting the polymer with a nucleophilic group, with optional inclusion of an ionomer with mixing and adding a 1,1-disubstituted alkene to the melt.

Disclosed is a method of polymerizing a 1,1-disubstituted alkene including the steps of melting a polymer with a nucleophilic group with mixing and adding a 1,1-disubstituted alkene to the melt.

Disclosed is a method of polymerizing a 1,1-disubstituted alkene including the steps of melting an ionomer with mixing and adding a 1,1-disubstituted alkene to the melt.

The compositions and methods disclosed herein may provide polymers with improved tensile strength and impact strength. In some instances the resultant polymers also have an improved aesthetic appearance. In addition, disclosed herein is that a variety of polymers with different nucleophilic groups can be used to initiate polymerization of 1,1-disubstituted alkenes. The polymer with a nucleophilic group may be recycled polymers. The amount of such recycled polymer may be any useful amount such as 1%, 10%, 25%, 50%, 75%, 90% to essentially 100% of the polymer with nucleophilic groups. Other polymers may be included in performing the methods if desired, but are not necessary.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure. The scope of the disclosure should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

One or more as used herein means that at least one, or more than one, of the recited components may be used as disclosed. Nominal as used with respect to functionality means the theoretical functionality, generally this can be calculated from the stoichiometry of the ingredients used. Generally, the actual functionality is different due to imperfections in raw materials, incomplete conversion of the reactants and formation of by-products. Residual content of a component refers to the amount of the component present in free form or reacted with another material, such as an oligomer or a polymer. Typically, the residual content of a component can be calculated from the ingredients utilized to prepare the component or composition. Alternatively, it can be determined utilizing known analytical techniques. Heteroatom means nitrogen, oxygen, sulfur and phosphorus, more preferred heteroatoms include nitrogen and oxygen. Hydrocarbyl as used herein refers to a group containing one or more carbon atom backbones and hydrogen atoms, which may optionally contain one or more heteroatoms. Where the hydrocarbyl group contains heteroatoms, the heteroatoms may form one or more functional groups well known to one skilled in the art. Hydrocarbyl groups may contain cycloaliphatic, aliphatic, aromatic, or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl, and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. As used herein percent by weight or parts by weight refer to, or are based on, the weight or the compositions unless otherwise specified.

The term “monofunctional” refers to 1,1-disubstituted alkene compounds having only one core unit. The core unit is represented by the combination of the carbonyl groups and the alkylene groups bonded to the 1 carbon atom. The term “difunctional” refers to 1,1-disubstituted alkenes compounds having two core formulas (containing a reactive alkene functionality) bound through a hydrocarbylene linkage between one oxygen atom on each of two core formulas. The term “multifunctional” refers to 1,1-disubstituted alkene compounds having more than one core unit (such as reactive alkene functionality) which may form a chain through a hydrocarbylene linkage between one heteroatom (oxygen atom) or direct bond on each of two adjacent core formulas. The term “stabilized” (e.g., in the context of “stabilized” 1,1-disubstituted alkene compounds or compositions comprising the same) refers to the tendency of the compounds (or their compositions) to substantially not polymerize with time, to substantially not harden, form a gel, thicken, or otherwise increase in viscosity with time, and/or to substantially show minimal loss in cure speed (i.e., cure speed is maintained) with time. The 1,1-disubstituted alkene compounds may be 1,1-dicarbonyl-1-alkene compounds.

Unless defined otherwise, all technical and scientific terms used herein have the meaning commonly understood by a person skilled in the art to which this disclosure belongs. The following references provide one of skill with a general definition of many of the terms used in this disclosure: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991).

Disclosed is a composition which includes a polymer which includes a nucleophilic group and a 1,1-disubstituted alkene disposed on the polymer.

The 1,1-dicarbonyl-1-alkene may be a dicarbonyl compound, 1,1-dicarbonyl-1-alkene compound, containing one or more ester groups, one or more keto groups, one or more amide groups, or a combination thereof. 1,1-disubstituted alkene compounds are compounds (e.g., monomers) wherein a central carbon atom is doubly bonded to another carbon atom to form an ethylene group. The central carbon atom is further bonded to two carbonyl groups. Each carbonyl group is bonded to a hydrocarbyl group through a direct bond, a nitrogen atom or an oxygen atom. Where the hydrocarbyl group is bonded to the carbonyl group through a direct bond, a keto group is formed. Where the hydrocarbyl group is bonded to the carbonyl group through an oxygen atom, an ester group is formed. Where the hydrocarbyl group is bonded to the carbonyl group through a nitrogen atom, an amido group is formed.

The 1,1-dicarbonyl-1-alkene may correspond to the formula:

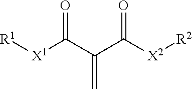

where X¹ and X² separately in each occurrence are an oxygen atom, a direct bond or —NR²; and R¹ and R² separately in each occurrence are hydrocarbyl groups, which are optionally substituted, that are the same or different. The 1,1-dicarbonyl-1-alkene may include ester groups corresponding to the formula:

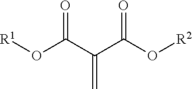

wherein R¹ and R², separately in each occurrence, may be hydrocarbyl groups, which are optionally substituted that are the same or different. R¹ and R², separately in each occurrence, may be C₁₋₁₂ alkyl, optionally substituted or C₅₋₁₂ cycloalkyl, optionally substituted. R¹ and R², separately in each occurrence, may be C₁₋₈ alkyl, optionally substituted or C₆₋₈ cycloalkyl, optionally substituted. R¹ and R², separately in each occurrence may be methyl, ethyl, hexyl, cyclohexyl, fenchyl, isobornyl or menthyl. R¹ may be methyl, ethyl, hexyl, cyclohexyl. R¹ may be the residue of a diol, polyol, hydroxy alkyl acrylate and the like. The 1,1 dicarbonyl 1-alkene may be diethylmethylenemalonate, dicyclohexylmethylenemalonate or dihexylmethylenemalonate. The 1,1 dicarbonyl 1-alkene may be dicyclohexylmethylene malonate or dihexylmethylenemalonate. The 1,1 dicarbonyl 1-alkene may correspond to one of the following formulas:

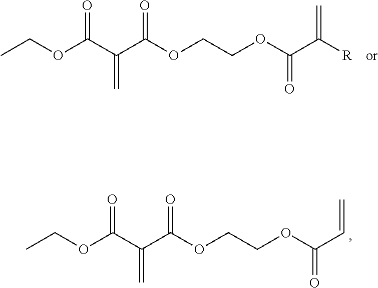

where R is C₁₋₈ alkyl which may be optionally substituted. It should be noted that the vinyl residue on the right is not limited to acrylates but may be a vinyl ether, vinyl ester, styrl, dienyl, acrylamide, etc. The 1,1 dicarbonyl 1-alkene may include keto groups corresponding to the formula:

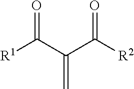

where R¹ and R², separately in each occurrence, are hydrocarbyl groups, which are optionally substituted that are the same or different. The 1,1 dicarbonyl 1-alkene may include one or more ester groups and one or more keto groups corresponding to the formula:

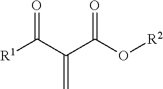

wherein R¹ and R², separately in each occurrence, are hydrocarbyl groups, which are optionally substituted that are the same or different. The 1,1 dicarbonyl 1-alkene may include one or more amide groups corresponding to the formula:

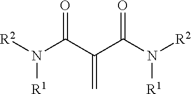

wherein R¹ and R², separately in each occurrence, is a hydrogen or a hydrocarbyl group, which is optionally substituted that are the same or different. Other combinations of ester groups, keto groups, and amide groups are also contemplated.

The hydrocarbyl groups (e.g., R¹ and R²), each comprise straight or branched chain alkyl, straight or branched chain alkyl alkenyl, straight or branched chain alkynyl, cycloalkyl, alkyl substituted cycloalkyl, aryl, aralkyl, or alkaryl. The hydrocarbyl group may optionally include one or more heteroatoms in the backbone of the hydrocarbyl group. The hydrocarbyl group may be substituted with a substituent that does not negatively impact the ultimate function of the monomer or the polymer prepared from the monomer. The substituents may be alkyl, halo, alkoxy, alkylthio, hydroxyl, nitro, cyano, azido, carboxy, acyloxy, and sulfonyl groups. The substituents may include alkyl, halo, alkoxy, alkylthio, and hydroxyl groups. The substituents may include halo, alkyl, and alkoxy groups.

As used herein, alkaryl means an alkyl group with an aryl group bonded thereto. As used herein, aralkyl means an aryl group with an alkyl group bonded thereto and include alkylene bridged aryl groups such as diphenyl methyl groups or diphenyl propyl groups. As used herein, an aryl group may include one or more aromatic rings. Cycloalkyl groups include groups containing one or more rings, optionally including bridged rings. As used herein, alkyl substituted cycloalkyl means a cycloalkyl group having one or more alkyl groups bonded to the cycloalkyl ring.

Hydrocarbyl groups include 1 to 30 carbon atoms, 1 to 20 carbon atoms or 1 to 12 carbon atoms. Hydrocarbyl groups with heteroatoms in the backbone may be alkyl ethers having one or more alkyl ether groups or one or more alkylene oxy groups. Alkyl ether groups may be ethoxy, propoxy or butoxy. Such compounds may contain from about 1 to about 100 alkylene oxy groups, about 1 to about 40 alkylene oxy groups, about 1 to about 12 alkylene oxy groups or about 1 to about 6 alkylene oxy groups.

One or more of the hydrocarbyl groups (e.g., R¹, R², or both), may be a C₁₋₁₅ straight or branched chain alkyl, a C₁₋₁₅ straight or branched chain alkenyl, a C₅₋₁₈ cycloalkyl, a C₆₋₂₄ alkyl substituted cycloalkyl, a C₄₋₁₈ aryl, a C₄₋₂₀ aralkyl, or a C₄₋₂₀ aralkyl. The hydrocarbyl group, may be a C₁₋₈ straight or branched chain alkyl, a C₅₋₁₂ cycloalkyl, a C₆₋₁₂ alkyl substituted cycloalkyl, a C₄₋₁₈ aryl, a C₄₋₂₀ aralkyl, or a C₄₋₂₀ aralkyl.

Alkyl groups may be methyl, propyl, isopropyl, butyl, tertiary butyl, hexyl, ethyl pentyl or hexyl groups. Alkyl groups may be methyl ethyl or hexyl. The cycloalkyl groups include cyclohexyl and fenchyl. Alkyl substituted groups may be menthyl or isobornyl. Hydrocarbyl groups attached to the carbonyl group include methyl, ethyl, propyl, isopropyl, butyl, tertiary, pentyl, hexyl, octyl, cyclohexyl, fenchyl, menthyl, and isobornyl. Hydrocarbyl groups attached to the carbonyl group include methyl, ethyl, hexyl, or cyclohexyl.

Monomers may be methylpropylmethylenemalonate, dihexylmethylenemalonate, di-isopropylmethylenemalonate, butylmethylmethylenemalonate, ethoxyethylethylmethylenemalonate, methoxyethylmethylmethylenemalonate, hexylmethylmethylenemalonate, dipentylmethylenemalonate, ethylpentylmethylenemalonate, methylpentylmethylenemalonate, ethylethylmethoxymethylenemalonate, ethoxyethylmethylmethylenemalonate, butylethylmethylenemalonate, dibutylmethylenemalonate, diethylmethylenemalonate, diethoxyethylmethylenemalonate, dimethylmethylenemalonate, di-cyclohexylmethylenemalonate, di-N-propylmethylenemalonate, ethylhexylmethylenemalonate, methylfenchylmethylenemalonate, ethylfenchylmethylene malonate, 2-phenylpropylethylmethylenemalonate, 3-phenylpropylethylmethylenemalonate or dimethoxyethylmethylenemalonate. Monomers may be dihexylmethylenemalonate, diethylmethylenemalonate, dimethylmethylenemalonate or di-cyclohexylmethylenemalonate.

Some or all of the 1,1-disubstituted alkenes may also be multifunctional having more than one core unit and thus more than one alkene group. Exemplary multifunctional 1,1-disubstituted alkenes are illustrated by the formula:

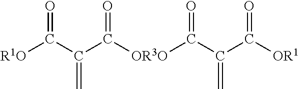

where R¹ separately in each occurrence is a hydrocarbyl group, which is optionally substituted, that are the same or different; R³ is C₂₋₈ alkyl optionally substituted or (—CHR⁴)ₙO); R⁴ is hydrogen or C₁₋₈ alkyl optionally substituted; and n is an integer from 2 to 8. R³ may be C₂₋₄ alkyl optionally substituted; R⁴ may be hydrogen or C₁₋₈ alkyl optionally substituted and n may be integer from 2 to 4. The 1,1-dicarbonyl-1 alkenes may contain about 0.1 percent by weight or greater of multifunctional 1,1-dicarbonyl-1 alkenes, or about 2 percent by weight or greater of multifunctional 1,1-dicarbonyl-1 alkenes. The multifunctional 1,1-disubstituted alkene may be present in an amount of about 0.1% to about 100% percent by weight of the 1,1-disubstituted alkene present. The 1,1-dicarbonyl-1 alkenes may contain about 33% by weight or less multifunctional 1,1-dicarbonyl-1 alkenes, about 5 percent by weight or less of multifunctional 1,1-dicarbonyl-1 alkenes, or about 1 percent by weight or less of multifunctional 1,1-dicarbonyl-1 alkenes.

The multifunctional monomers may be prepared from 1,1-diester-1-alkenes and polyols, including diols. Where the polyol has greater than two hydroxyl groups, preparation of a multifunctional monomer is desired before chain extension. Multifunctional monomers comprise a polyol wherein at least two of the hydroxyl groups are replaced by the residue of 1,1-diester-1-alkenes. Where there are greater than two hydroxyl groups on the polyol it is possible that not all of the hydroxyl groups react with 1,1-diester-1-alkenes. It is desirable to react substantially all of the hydroxyl groups with the 1,1-diester-1-alkenes. The alternatives discussed hereinbefore for the polyols and 1,1-diester-1-alkenes as far as structure are also applicable to the multifunctional monomers. When a polyol with 3 or greater hydroxyl groups are used to prepare the multifunctional monomers they correspond to the formula:

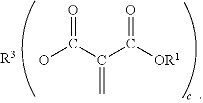

When diols are used to prepare the multifunctional monomers they correspond to formula:

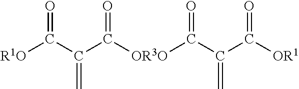

where R¹ and R³ are as defined above and c is greater than 1. The multifunctional monomers can be prepared as disclosed in Malofsky et al., U.S. Patent Application No. 2014/0329980, Sullivan et al., U.S. Pat. No. 9,416,091 and Palsule et al., U.S. Pat. No. 9,617,377.

Some or all of the 1,1-disubstituted alkenes may also be polyester macromers which contain one or more chains containing the residue of one or more diols and one or more diesters wherein a portion of the diesters comprise 1,1-diester-1-alkenes. The residue of the diols and the diesters can alternate along the chains or can be disposed randomly along the chains. The diesters may further comprise any diester compound that will undergo transesterification with a polyol or diol. Among diester compounds are dihydrocarbyl dicarboxylates. The polyester macromers may have three or more chains as described. The polyester macromers having three or more chains contain the residue of a polyol originally having three or greater hydroxyl groups. The three or more chains propagate from each of the three or more hydroxyl groups. The polyols having three or more chains function as initiators from which each of the chains of the polyester macromers propagate. If the polyol is a diol a single chain is produced because the macromer formed is linear. Where a polyol having three or more hydroxyls is used to prepare the macromer, it may have two or more chains as not all of the hydroxyls may propagate chains. The macromers may contain one or more chains, may contain two or more chains, or may contain three or more chains. The macromers may contain eight or less chains, six or less chains, four or less chains or three or less chains. The chains may comprise the residue of one or more polyols, one or more diols and one or more diesters, including one or more 1,1-diester-1-alkenes and optionally one or more dihydrocarbyl dicarboxylates. The chains may comprise the residue of one or more diols and one or more diesters, including one or more 1,1-diester-1-alkenes and optionally one or more dihydrocarbyl dicarboxylates. The polyester macromers contain the residue of at least one 1,1-diester-1-alkenes at the terminal end of one of the chains. The polyester macromers may further comprise one or more diols or dihydrocarbyl dicarboxylates at the terminal end of one or more of the chains. Substantially all of the terminal ends of chains may be 1,1-diester-substituted alkenes.

The polyester macromers may comprise sufficient amount of the residue of one or more polyols, in this context the polyols have 3 or greater hydroxyl groups, to initiate the desired number of chains. The residue of the polyols in the polyester macromers may be about 20 mole percent or greater of the macromer; 30 mole percent or greater or about 40 mole percent or greater. The residue of the polyols in the polyester macromers may be about 50 mole percent or less; or about 40 mole percent or less. The polyester macromers may comprise sufficient amount of the residue of one or more diols, in this context the polyols have 2 hydroxyl groups, to prepare polyester macromers having the desired chain length and number average molecular weight. The residue of the diols in the polyester macromers may be about 20 mole percent or greater of the macromer; 40 mole percent or greater or about 50 mole percent or greater. The residue of the diols in the polyester macromers may be about 50 mole percent or less; 40 mole percent or less or about 30 mole percent or less. The polyester macromers may comprise sufficient amount of the residue of the 1,1-diester-substituted-1-alkenes to provide the desired crosslink density to compositions containing the polyester macromers. The residue of the 1,1-diester-substituted-1-alkenes in the polyester macromers may be about 20 mole percent or greater of the macromer; 30 mole percent or greater or about 40 mole percent or greater. The residue of the 1,1-diester-substituted-1-alkenes in the polyester macromers may be about 60 mole percent or less of the macromer; about 50 mole percent or less of the macromer; about 40 mole percent or less or about 30 mole percent or less. The polyester macromers may comprise sufficient amount of the residue of the dihydrocarbyl dicarboxylates to provide the desired space between crosslinks to compositions containing the polyester macromers to provide the desired flexibility and/or elasticity to the structures containing the polyester macromers. The residue of the dihydrocarbyl dicarboxylates in the polyester macromers may be about 10 mole percent or greater of the polyester macromer; 20 mole percent or greater or about 30 mole percent or greater. The residue of the dihydrocarbyl dicarboxylates in the polyester macromers may be about 30 mole percent or less of the polyester macromer; 20 mole percent or less or about 10 mole percent or less.

The polyester macromers may correspond to Formula 1

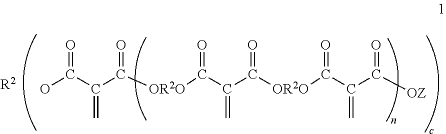

wherein Z is separately in each occurrence —R²OH or —R¹; R¹ is separately in each occurrence a hydrocarbyl group which may contain one or more heteroatoms; R² is separately in each occurrence a hydrocarbylene group having two or more bonds to oxygen atoms; c is an integer of 1 or more; and n is an integer of about 1 to 3. With respect to R² the bonds to oxygen atoms may include bonds to the oxygen of a polyol, a diol, or a diester or the residue thereof depending on the context of use of R².

The polyester macromers may contain one chain of the residue of one or more diols and one or more diesters. These polyester macromers may correspond to Formula 2,

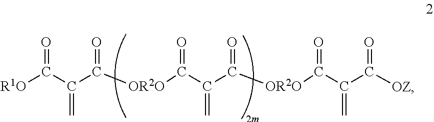

wherein Z, R¹ and R² are as previously defined; and m is an integer of about 1 to 3.

The polyester macromers containing the residue of one or more 1,1-diester-1-alkenes and the residue of one or more dihydrocarbyl dicarboxylates may correspond to one of Formulas 3 to 6:

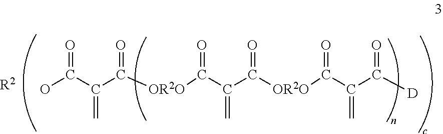

wherein D corresponds to the formula

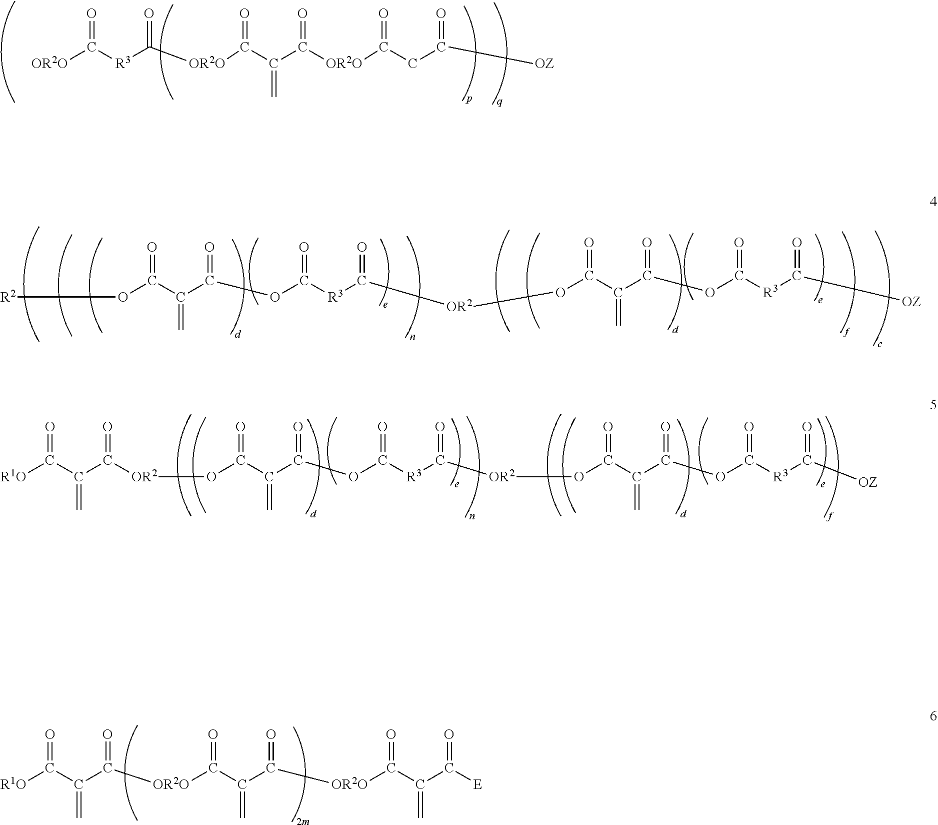

wherein E corresponds to the formula,

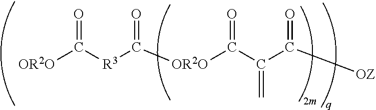

wherein Z, R¹, R² and m are as previously defined; R³ is separately in each occurrence a hydrocarbylene group having two bonds to the carbonyl groups of one or more of the diesters or to the residue of such diesters depending on the context, wherein the hydrocarbylene group may contain one or more heteroatoms; c is an integer of 1, or 2 or more; d is an integer of 0 or 1; e is an integer of 0 or 1; f is the integer 1; n is an integer of about 1 to 3; p is an integer of 2 or more; and q is an integer of 1 or more; wherein each pair of d and e must equal 1. p may be an integer of 3 or greater. p may be an integer of 8 or less, 6 or less or 3 less. q may be an integer of 4 or less or 3 or less.

The polyester macromers may contain in their backbone repeating units comprising the residue of at least one diester and one diol. A significant portion of the diesters are 1,1-diestersubstituted-1-alkenes. A portion of the diesters may be 1,1-dihydrocarbyl dicarboxylates. The backbone of polyester macromers contain a sufficient number of repeating units comprising the residue of at least one diester and one diol to facilitate the use of the polyester macromers as disclosed herein, such as in coatings. The number of repeating units comprising the residue of at least one diester and one diol in polyester macromers may be 2 or greater, 4 or greater or 6 or greater. The number of repeating units comprising the residue of at least one diester and one diol in polyester macromers may be 20 or less, 14 or less, 10 or less, 8 or less, 6 or less, or 4 or less. The diesters in some polyester macromers can be all 1,1-diester-1-alkenes. The diesters in some polyester macromers can be 1,1-diester-1-alkenes and dihydrocarbyl dicarboxylates. The molar ratio of 1,1-diester-1-alkenes and dihydrocarbyl dicarboxylates in some polyester macromers is selected to provide the desired degree of crosslinking in structures prepared from the polyester macromers. The molar ratio of 1,1-diester-1-alkenes and dihydrocarbyl dicarboxylates in some polyester macromers may be 1:1 or greater, 6:1 or greater or 10:1 or greater. The molar ratio of 1,1-diestersubstituted-1-alkenes and dihydrocarbyl dicarboxylates in some polyester macromers may be 15:1 or less, 10:1 or less, 6:1 or less or 4:1 or less. The polyester macromers may exhibit a number average molecular weight of about 700 or greater, about 900 or greater, about 1000 or greater or about 1200 or greater. The polyester macromers may exhibit a number average molecular weight of about 3000 or less, about 2000 or less or about 1600 or less. Number average molecular weight as used herein is determined dividing total weight of all the polymer molecules in a sample, by the total number of polymer molecules in a sample. The polydispersity of the polyester macromers may be about 1.05 or greater or about 1.5 or greater. The polydispersity of the polyester macromers may be about 4.5 or less or about 2.5 or less, about 2.5 or less or about 1.5 or less. For calculating the polydispersity the weight average molecular weight is determined using gel permeation chromatography using polymethylmethacrylate standards. Polydispersity is calculated by dividing the measured weight average molecular weight (Mu) by the number average molecular weight (Mₙ), that is M_{v/} Mₙ.

Polyols are compounds having a hydrocarbylene backbone with two or more hydroxyl groups bonded to the hydrocarbylene backbone and which may capable of transesterifying with ester compounds under the transesterification conditions disclosed in the references above. Polyols useful herein fall in two groups. The first group are diols which have two hydroxyl groups bonded to a hydrocarbylene backbone and which function both to initiate and extend the chains of the polyester macromers. Polyols with greater than two hydroxyl groups bonded to the hydrocarbylene backbone function to initiate more than two chains. Diols may also function to extend the more than two chains. The polyols may have from 2 to 10 hydroxyl groups, from 2 to 4 hydroxyl groups or from 2 to 3 hydroxyl groups. The backbone for the polyols, including diols, may be alkylene, alkenylene, cycloalkylene, heterocyclylene, alkyl heterocyclylene, arylene, aralkylene, alkarylene, heteroarylene, alkheteroarylene, or polyoxyalkylene. The backbone may be C₁₋₁₅ alkylene, C₂₋₁₅ alkenylene, C₃₋₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The alkylene sections may be straight or branched. The recited groups may be substituted with one or more substituents which do not interfere with the transesterification reaction. Exemplary substituents include halo alkylthio, alkoxy, hydroxyl, nitro, azido, cyano, acyloxy, carboxy, or ester. The backbone may be C₂₋₁₀ alkylene groups. The backbone may be a C₂₋₈ alkylene group, which may be straight or branched, such as ethylene, propylene, butylene, pentylene, hexylene, 2-ethyl hexylene, heptylene, 2-methyl 1,3 propylene or octylene. The diols having a methyl group at the 2 position of an alkylene chain may be used. Exemplary diols include ethane diol, propane diol, butane diol, pentane diol, hexane diol, 2 ethyl hexane diol, heptane diol, octane diol, 2-methyl 1,3 propylene glycol, neopentyl glycol and 1,4-cyclohexanol. The polyol may correspond to the formula: R² [symbol] OH)_{c}; the diol may correspond to the formula: HO—R²—OH; where R² is separately in each occurrence a hydrocarbylene group having two or more bonds to the hydroxyl groups of a polyol. R² may be separately in each occurrence alkylene, alkenylene, cycloalkylene, heterocyclylene, alkyl heterocyclylene, arylene, aralkylene, alkarylene, heteroarylene, alkheteroarylene, or polyoxyalkylene. R² may be separately in each occurrence C₁₋₁₅ alkylene, C₂₋₁₅ alkenylene, C₃₋₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The recited groups may be substituted with one or more substituents which do not interfere with the transesterification reaction. Exemplary substituents include halo, alkylthio, alkoxy, hydroxyl, nitro, azido, cyano, acyloxy, carboxy, or ester. R² may be separately in each occurrence a 02-8 alkylene group, such as ethylene, propylene, butylene, pentylene, hexylene, 2-ethyl hexylene, heptylene, 2-methyl 1,3 propylene or octylene. Exemplary C₃₋₀₉ cycloalkylenes include cyclohexylene. The alkylene groups may be branched or straight and may have a methyl group on the 2 carbon. Alkarylene polyols include polyols with the structure of -aryl-alkyl-aryl-(such as -phenyl-methyl-phenyl- or -phenyl-propyl-phenyl-) and the like. Alkyl cycloalkylene polyls include those with the structure of -cycloalkyl-alkyl-cycloalkyl-(such as -cyclohexyl-methyl-cyclohexyl- or -cyclohexyl-propyl-cyclohexyl-) and the like. c may be an integer of 8 or less, 6 or less, 4 or less, or 3 or less and c may be an integer of 1 or greater, 2 greater or 3 or greater.

Macromers may crosslink the polymer while monomers may be grafted on the polymer. Addition of macromers may result in a more rapid increase in viscosity while addition of monomers may show a more gradual increase. The latter may correspond to grafting and branching while the former may be related to crosslinking. Depending on the application, either macromers or monomers may be used or a combination thereof.

The 1,1-disubstituted alkene compound is prepared using a method which results in a sufficiently high purity so that it can be polymerized. The purity of the 1,1-disubstituted alkene compound may be sufficiently high so that 70 mole percent or more, 80 mole percent or more, 90 mole percent or more, 95 mole percent or more, or 99 mole percent or more of the 1,1-disubstituted alkene compound is converted to polymer during a polymerization process. The purity of the 1,1-disubstituted alkene compound is about 85 mole percent or more, about 90 mole percent or more, about 93 mole percent or more, about 95 mole percent or more, about 97 mole percent or more or about 99 mole percent or more, based on the total weight of the 1,1-disubstituted alkene compound. If the 1,1-disubstituted alkene compound includes impurities, about 40 mole percent or about 50 mole percent or more of the impurity molecules are the analogous 1,1-disubstituted alkane compound. The concentration of any impurities having a dioxane group is about 2 mole percent or less, about 1 mole percent or less, about 0.2 mole percent or less, or about 0.05 mole percent or less, based on the total weight of the 1,1-disubstituted alkene compound. The total concentration of any impurity having the alkene group replaced by an analogous hydroxyalkyl group (e.g., by a Michael addition of the alkene with water), is about 3 mole percent or less, about 1 mole percent or less, about 0.1 mole percent or less, and about 0.01 mole percent or less, based on the total moles in the 1,1-disubstituted alkene compound. The 1,1-disubstituted alkene compounds are prepared by a process including one or more (e.g., two or more) steps of distilling a reaction product or an intermediate reaction product (e.g., a reaction product or intermediate reaction product of a source of formaldehyde and a malonic acid ester).

The 1,1-disubstituted alkene compound may include a monomer produced according to the teachings of Malofsky et al., U.S. Pat. No. 8,609,885. Other examples of monomers which may be employed include the monomers taught in International Patent Application Publication Nos. WO2013/066629 and WO 2013/059473.

Disclosed is a composition which includes a polymer which includes a nucleophilic group; and a 1,1-disubstituted alkene disposed on the polymer. The composition may further include an ionomer. The compositions may contain a mixture of the various 1,1-disubstituted alkenes disclosed herein. The mixture may include one or more monofunctional 1,1-disubstituted alkenes and one or more of the multifunctional monomers and/or the polyester macromers.

The nucleophilic group attached to a polymer may be a carboxylic acid, carboxylate, alcohol, phenol, amine, aniline, imidazole, tetrazole, thiol, boronic acid, boronic acid salts, glycol, hydrazine, hydroxyl amine group or combinations thereof. The nucleophilic group may be an amine, a salt thereof or analcohol.

The nucleophilic group may be pendant from a polymer backbone. The nucleophilic group may be at the end of a polymer backbone. The nucleophilic group may be grafted to the polymer backbone. The polymer with a nucleophilic group pendant from the backbone may be an ionomer. The polymer may be condensation polymer such as a polyamide polymer, a glycol polymer (e.g., polyether alcohol) or a polyester polymer. The polymer having a nucleophilic group at the end of the backbone may be NYLON 6, NYLON 66, polyethylene glycol or polyethylene terephthalate. The polymer having a nucleophilic group grafted to the backbone may be polymers of radically polymerizable monomers wherein at least a portion of the radically polymerizable monomers have pendant nucleophilic groups such as acrylic acid (e.g., copolymers of ethylene and acrylic acid). The polymer which includes the nucleophilic group may be an ionomer which may include a lithium carboxylate, a magnesium carboxylate a zinc carboxylate or combinations thereof. The ionomer may be an apex polymer such as those available under the tradename CRYSTALENE (e.g., CRYSTALENE 0119C (Mg counterion), CRYSTALENE 0215D (Li counterion) or CRYSTALENE 011564. (Zn counterion).

Also disclosed is method of making a composition which contains a polymer which includes a nucleophilic group and a 1,1-disubstituted alkene. The method includes the step of mixing the polymer which includes a nucleophilic group and a 1,1-disubstituted alkene. The polymer may heated at temperature compatible with melt processing which may vary with the polymer structure. For example, the melt processing temperature of polyamides is typically around 240° C. or 250° C. while those of other polymers, generally, will be lower.

Also disclosed is a method of chain extending or cross linking a polymer with a nucleophilic group with a 1,1-disubstituted alkene. The method includes the steps of melting the polymer with a nucleophilic group. The chain extending or cross-linking may be facilitated by the further addition of an ionomer.

Also disclosed is a method of polymerizing a 1,1-disubstituted alkene. The method includes the steps of melting a polymer with a nucleophilic group, with optional inclusion of an ionomer, with mixing and adding a 1,1-disubstituted alkene to the melt. Also disclosed is another method of polymerizing a 1,1-disubstituted alkene. The method includes the steps of melting an ionomer with mixing and adding a 1,1-disubstituted alkene to the melt. The method disclosed herein may result in chain extension, crosslinking or combination thereof of the polymer having a nucleophilic group and/or homopolymerization of the 1,1-disubstituted alkene within the melted polymer having a nucleophilic group. Generally, depending on the melt conditions, there typically will be a proportion of each of these (i.e., chain extension, crosslinking and homopolymerzation), but in some instances, homopolymerization will occur forming a blended polymer composition.

The polymer, which includes a nucleophilic group may be melted at a temperature greater than or equal to 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C. or 290° C. The polymer may be melted at a temperature less than or equal to 295° C., 285° C., 275° C., 265° C., 255° C. or 245° C., 235° C., 225° C., 215° C., 205° C., 195° C., 185° C., 175° C., 165° C., 155° C., 145° C., 135° C., 125° C., 115° C. or 105° C.

The polymer which includes a nucleophilic group may be present in any useful amount. The polymer, which includes a nucleophilic group may be present in an amount of 1% or 10% to 55%, 65%, 75%, 85%, 95% or 97% by weight of the copolymer formed.

The ionomer may be present in an amount of 1%, 10%, 15% to 55%, 65%, 75%, 85%, 95% or 97% by weight. Desirably, the ionomer is present with the polymer with the nucleophilic group with the amount being, for example, about 1%, 5% to about 20%, 15% or 10% by weight of the copolymer formed.

The 1,1-disubstituted alkene, may be present in any useful amount such as from of 1% or 10% to 55%, 65%, 75%, 85%, 95% or 97% by weight of the copolymer formed. Generally, when the copolymer to be formed is rehabilitating a recycled condensation polymer, the amount of 1,1-disubstituted alkene typically that is used is about 1%, 2%, or 5% to about 25%, 20%, 15% or 10% of the copolymer formed.

Stabilizers may be used to stabilize the copolymer of the invention such as those commonly employed such as antioxidants, UV stabilizers, antifungals and the like. The stabilizers may be present in an amount of about 0.1%, 1%, 2% to about 10% by weight of the copolymer.

The multifunctional monomers may be present in an amount less than or equal to 10%, 7.5%, 5%, 2.5% or 1% by weight. The multifunctional monomers may be present in an amount greater than or equal to 9%, 6%, 4%, 2% or 0.5% by weight.

The 1,1-disubstituted alkene compositions may further contain other components to stabilize the compositions prior to exposure to polymerization conditions or to adjust the properties of the final polymer for the desired use. For example, a suitable plasticizer can be included with a reactive composition. Exemplary plasticizers are those used to modify the rheological properties of adhesive systems including, for example, straight and branched chain alkyl-phthalates such as diisononyl phthalate, dioctyl phthalate, and dibutyl phthalate, trioctyl phosphate, epoxy plasticizers, toluene-sulfamide, chloroparaffins, adipic acid esters, sebacates such as dimethyl sebacate, castor oil, xylene, 1-methyl-2-pyrrolidone and toluene. Commercial plasticizers such as HB-40 partially hydrogenated terpene manufactured by Solutia Inc. (St. Louis, Mo.) can also be suitable. For example, one or more dyes, pigments, toughening agents, impact modifiers, rheology modifiers, natural or synthetic rubbers, filler agents, reinforcing agents, thickening agents, opacifiers, inhibitors, fluorescence markers, thermal degradation reducers, thermal resistance conferring agents, surfactants, wetting agents, or stabilizers can be included in a polymerizable system. For example, thickening agents and plasticizers such as vinyl chloride terpolymer (comprising vinyl chloride, vinyl acetate, and dicarboxylic acid at various weight percentages) and dimethyl sebacate respectively, can be used to modify the viscosity, elasticity, and robustness of a system. The thickening agents and other compounds can be used to increase the viscosity of a polymerizable system from about 1 to 3 cPs to about 30,000 cPs, or more.

Stabilizers can be included in the 1,1-disubstituted alkenes to increase and improve the shelf life and to prevent spontaneous polymerization. One or more anionic polymerization stabilizers and or free-radical stabilizers may be added to the compositions. Anionic polymerization stabilizers are generally electrophilic compounds that scavenge bases and nucleophiles from the composition or growing polymer chain. The use of anionic polymerization stabilizers can terminate additional polymer chain propagation. Exemplary anionic polymerization stabilizers are acids, exemplary acids are carboxylic acids, sulfonic acids, phosphoric acids and the like. Exemplary stabilizers include liquid phase stabilizers (e.g., methanesulfonic acid (“MSA”)), and vapor phase stabilizers (e.g., trifluoroacetic acid (“TFA”)). Free-radical stabilizers may include phenolic compounds (e.g., 4-methoxyphenol or mono methyl ether of hydroquinone (“MeHQ”) and butylated hydroxy toluene (BHT)). Stabilizer packages for 1,1-disubstituted alkenes are disclosed in Malofsky et al., U.S. Pat. No. 8,609,885 and Malofsky et al., U.S. Pat. No. 8,884,051. Additional free radical polymerization inhibitors are disclosed in Sutoris et al., U.S. Pat. No. 6,458,956. Generally, only minimal quantities of a stabilizer are needed and, only about 150 parts-per-million or less may be included. A blend of multiple stabilizers may be included such as, for example a blend of anionic stabilizers (MSA) and free radical stabilizers (MeHQ). The one or more anionic polymerization stabilizers are present in sufficient amount to prevent premature polymerization. The anionic polymerization stabilizers may be present in an amount of about 0.1 part per million or greater based on the weight of the monomers, about 1 part per million by weight or greater or about 5 parts per million by weight or greater. The anionic polymerization stabilizers may be present in an amount of about 1000 parts per million by weight or less based on the weight of the monomers, about 500 parts per million by weight or less or about 100 parts per million by weight or less. The one or more free radical stabilizers are present in sufficient amount to prevent premature polymerization. The free radical polymerization stabilizers may be present in an amount of about 1 parts per million or greater based on the weight of the monomers, about 5 parts per million by weight or greater or about 10 parts per million by weight or greater. The free radical polymerization stabilizers may be present in an amount of about 5000 parts per million by weight or less based on the weight of the monomers, about 1000 parts per million by weight or less or about 500 parts per million by weight or less.

Addition of 1,1-disubstituted alkenes to polymer melts as processing aids as described herein may increase tensile properties and impact strength of the polymer without affecting other polymer characteristics. Generally, substantial increases in the processing viscosity of the melt may provide about 10-15% increase in tensile strength and impact strength of the polymer without affecting other polymer properties. The amount that the viscosity increases at a given shear rate as given by the torque increase in an extruder in the melt may depend on the amount and type of 1,1-disubstituted alkene added to the melt. The torque increase is also indicative of the polymerization of the 1,1-discubstitured alkene as described herein.

The 1,1-disubstituted alkenes may be added in liquid form or via a solid carrier to a polymer which includes a nucleophilic group such as an inorganic particulate. There may be advantages to locating 1,1-disubstituted alkenes at specific locations of the polymer, which may be realizable using solid carriers. For example, if the nucleophilic group is at the terminal position of the polymer, localization at the chain ends may lead to chain extension and crosslinking with a substantial viscosity increase, which may be due to constraint of the 1,1-disubstituted alkene on the surface of the particulate surface.

The 1,1-disubstituted alkenes may be mixed with a polymer which includes a nucleophilic group with shear, which may be performed in an extruder or mixer. The time of mixing may be any useful time and typically is at least about 20 seconds, 30 seconds, 1 minute, 3 minutes or 5 minutes to any useful or practicable time such as 1 or 2 hours.

### Illustrative Embodiments

The following examples are provided to illustrate the disclosed compositions but are not intended to limit the scope thereof. All parts and percentages are by weight unless otherwise stated.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, from 20 to 80, from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Sirrus materials used in this work were dicyclohexyl methylene malonate (DCHMM) and a multifunctional material based on diethyl methylene malonate (DEMM) and butane diol with an average molecular weight between 1000-1500 daltons and an average functionality of 5-7. The tradename for this product is Forza B4000 XP.

### Example 1: Haake Bowl Mixing Trials

The following plastic components of the formulations as shown in Table 1 are mixed in a Haake bowl at 150° C. at 100 rpm, until the viscosity (as measure by the torque of the instrument) of the melt equilibrates. Then a predetermined amount of Forza B4000 XP methylene malonate macromer (diethyl methylene malonate (DEMM) and butane diol with an average molecular weight between 1000-1500 daltons and an average functionality of 5) is added in through a port. The increase in torque and viscosity after addition of the macromer is measured after equilibration. The mixing bowl is mixed for a few minutes after the viscosity is recorded to observe for any indications of decomposition.

TABLE 1
Various ionomers, stabilizers and methylene malonate macromer
in Haake mixing bowl

| | Study 1 | | Study 2 | | Study 3 | |
|---|---|---|---|---|---|---|
| Components | % | g | % | g | % | g |
| Apex polymer | | | 97.5 | 39 | | |
| crystalline 0119C (Mg | | | | | | |
| ion based) | | | | | | |
| Apex polymer | | | 97.5 | 39 | | |
| crystalline 0215D (Li | | | | | | |
| ion based) | | | | | | |
| Apex polymer | | | | | 97.5 | 39 |
| crystalline 0115B (Zn | | | | | | |
| ion based) | | | | | | |
| Maroon Evernox 10 | 0.25 | 0.1 | 0.25 | 0.1 | 0.25 | 0.1 |
| Maroon Everfos 168 | 0.25 | 0.1 | 0.25 | 0.1 | 0.25 | 0.1 |
| Sirrus Forza B4000 XP | 2.0 | 0.8 | 2 | 0.8 | 2 | 0.8 |

| | | | |
|---|---|---|---|
| Torque Increase (%) | 13 | 12 | 40 |

After addition of 2% Forza B4000 XP (diethyl methylene malonate (DEMM) and butane diol with an average molecular weight between 1000-1500 daltons and an average functionality of 5), a torque increase of around 13% (from 12.3 N.m to 13.9 N.m at 5 minutes after addition) is seen in Study 1 and is maintained for at least 8 minutes after addition indicating the resulting polymer is thermally stable at the processing temperature of 150° C. Addition of higher loading of Sirrus Forza B4000 XP does not show an improvement in torque, but resulted in screw slippage due to plasticization. The above confirms initiation of polymerization using magnesium based ionomer salt polymer.

Similar observations are made in study 2 after addition of 2% Forza B4000 XP (diethyl methylene malonate (DEMM) and butane diol with an average molecular weight between 1000-1500 daltons and an average functionality of 5) with a lithium based ionomer salt polymer where a 12% (12.5 N.m to 14 N.m) rise in torque is confirmed. Similar thermal stability is observed as in Study 1.

For the zinc based ionomer salt polymer, upwards of 40% (26 N.m to 37 N.m) increase in torque is seen for the addition of 2% Sirrus Forza B4000 XP (diethyl methylene malonate (DEMM) and butane diol with an average molecular weight between 1000-1500 daltons and an average functionality of 5) and the thermal stability is maintained for 5-8 minutes after macromer addition.

### Example 2: Zinc Ionomer, Stabilizers and Methylene Malonate Macromer in Haake Mixing Bowl

The zinc based ionomer is used and the loadings of Forza B4000 XP (diethyl methylene malonate (DEMM) and butane diol with an average molecular weight between 1000-1500 daltons and an average functionality of 5) and Chemilian H4000 XP (DCHMM monomer) is varied. The following components of the formulations are mixed in a Haake bowl at 150° C. at 100 rpm, until the viscosity (as measure by the torque of the instrument) of the melt equilibrates. The following formulations described in Table 2 are made.

TABLE 2
Formulations mixed with various Zinc based ionomers, stabilizers and
methylene malonate macromer/monomers in the Haake mixing bowl

| | Study 1 | | Study 2 | | Study 3 | |
|---|---|---|---|---|---|---|
| Components | % | g | % | g | % | g |
| Apex polymer | 97.5 | 39 | 98.5 | 39.4 | 97.5 | 39 |
| crystalline 0115B (Zn | | | | | | |
| ion based) | | | | | | |
| Maroon Evernox 10 | 0.25 | 0.1 | 0.25 | 0.1 | 0.25 | 0.1 |
| Maroon Everfos 168 | 0.25 | 0.1 | 0.25 | 0.1 | 0.25 | 0.1 |
| Sirrus Forza B4000 XP | 2.0 | 0.8 | 1 | 0.4 | 1 | 0.4 |
| Sirrus Chemilian H4000 | | | | | 1 | 0.4 |
| XP | | | | | | |

| | | | |
|---|---|---|---|
| Torque Increase (%) | 43 | 26 | 57 |

Torque increase of around 43% is confirmed for 2% addition of Sirrus Forza B4000 XP in Study 1. For 1% addition of Sirrus Forza B4000 XP, a 26% increase in torque (from 25.2 N.m to 32 N.m) is observed 10 minutes after addition in Study 2. Considerable thermal and oxidative stability is observed at the 150° C. processing temperature. In study 3, where a mixture of H4000 and B4000 was added, a 57% increase in torque is observed 10 minutes after addition. This monomer mixture results in chain extension and crosslinking and may be have a synergistic effect in viscosity increase. Thus, zinc based ionomers is an effective initiator for methylene malonate based monomers during processing conditions.

### Example 3: NYLON 6 Polyamide Virgin Plastic Mixed with/without Various Zinc Based Ionomers, Stabilizers and Methylene Malonate Macromer/Monomers in the Haake Mixing Bowl

These experiments are conducted with NYLON 6 polyamide virgin plastic grade with and without addition of zinc based ionomer from the previous experiments. The formulations are shown in Table 3 below.

TABLE 3
Formulations of NYLON 6 virgin polyamide plastic mixed with/without
various zinc based ionomers, stabilizers and methylene malonate
macromer/monomers in the Haake mixing bowl

| Com- | Study 1 | | Study 2 | | Study 3 | | Study 4 | | Study 5 | | Study 6 | |
|---|---|---|---|---|---|---|---|---|---|---|---|---|
| ponents | % | g | % | g | % | g | % | g | % | g | % | g |
| BASF | 99.75 | | 39.9 | 97.75 39.1 | 98.75 | 39 | 95.75 38.3 | 97.75 | 39.1 | 97.7 5 | 39.1 | |
| Ultramid | | | | | | | | | | | | |
| 8202 HS | | | | | | | | | | | | |
| Addipel | 0.25 | 0.1 | 0.25 | 0.1 | 0.25 | 0.1 | 0.25 | 0.1 | 0.25 | 0.1 | 0.25 | 0.1 |
| WPHSL | | | | | | | | | | | | |
| Apex | | | | | | | 2 | 0.8 | 1 | 0.4 | 1 | 0.4 |
| polymer | | | | | | | | | | | | |
| crystalline | | | | | | | | | | | | |
| 0115B (Zn | | | | | | | | | | | | |
| ion based) | | | | | | | | | | | | |
| Sirrus | | | 2 | 0.8 | 1 | 0.4 | 2 | 0.8 | 1 | 0.4 | | |
| Forza | | | | | | | | | | | | |
| B4000 XP | | | | | | | | | | | | |
| Sirrus | | | | | | | | | | | 1 | 0.4 |
| Chemilian | | | | | | | | | | | | |
| H4000 XP | | | | | | | | | | | | |

| | | | | | |
|---|---|---|---|---|---|
| Torque | 20 | 9.6 | 18 | 10 | 144 |
| Increase | | | | | |
| (%) | | | | | |

In study 1, the baseline torque is 7.7 torque and is steady for 10 minutes. In study 2, addition of 2% Sirrus Forza B4000 XP ((diethyl methylene malonate (DEMM) and butane diol with an average molecular weight between 1000-1500 daltons and an average functionality of 5) results in the torque increasing from 7.7 N.m to 9.3 N.m in 2 minutes (20% increase). In study 3, addition of 1% Sirrus Forza B4000 XP ((diethyl methylene malonate (DEMM) and butane diol with an average molecular weight between 1000-1500 daltons and an average functionality of 5) results in a torque increase of 9.6% (from 8.3 N.m to 9.1 N.m) after 2 minutes. The above confirms that NYLON 6 polymer has a group in the main chain of the polymer that initiates methylene malonate polymerization which leads to an increase in viscosity of the mixture.

In study 4, an 18% increase in torque is observed which is comparable to the torque increase seen in study 2, which may indicate that initiation from NYLON dominates any initiation from the ionomer, due to lower concentration of initiating species in the ionomer. Similar behavior is seen in study 5 with only a 10% increase in torque.

In study 6, addition of 1% DCHMM results in an 14.4% increase in torque even in the presence of ionomer. If the bulk of the initiation is due to amine groups in the NYLON polyamide chain, this is a pure chain extension as DCHMM cannot crosslink. The increase in torque accordingly is more gradual but higher than the corresponding experiment with the macromer (study 5 was 10%).

The processing of NYLON 6 polyamide was conducted at 100 rpm at 240° C. and the resultant methylene malonate polymers are stable at those temperatures for a few minutes as can be seen from the viscosity being maintained for several minutes. As most processing operations are only a few seconds long, this is a useful timeframe to study the thermal stabilities of the methylene malonate based chain extension/crosslinking.

### Example 4: Virgin and Recycled PET with Various Zinc Based Ionomers, Stabilizers and Methylene Malonate Macromer/Monomers in the Haake Mixing Bowl

The next round of experiments were conducted with virgin and recycled PET resin with addition of zinc based ionomer from the previous experiments. The formulations are shown in Table 4 below.

TABLE 4
Formulations of virgin and recycled PET with various Zinc based ionomers,
stabilizers and methylene malonate macromer/monomers in the Haake mixing bowl

| | Study 1 | | Study 2 | | Study 3 | | Study 4 | |
|---|---|---|---|---|---|---|---|---|
| Components | % | g | % | g | % | g | % | g |
| Polyquest | 99.50 | 39.8 | 95.5 | 38.2 | | | | |
| PQB7-076 | | | | | | | | |
| (virgin PET) | | | | | | | | |
| Polyquest | | | | | 99.50 | 39.8 | 95.5 | 38.2 |
| PQPCR(068)-D | | | | | | | | |
| (Recycled PET) | | | | | | | | |
| Maroon | 0.25 | 0.1 | 0.25 | 0.1 | 0.25 | 0.1 | 0.25 | 0.1 |
| Evernox 10 | | | | | | | | |
| Maroon | 0.25 | 0.1 | 0.25 | 0.1 | 0.25 | 0.1 | 0.25 | 0.1 |
| Everfos 168 | | | | | | | | |
| Apex polymer | | | 2 | 0.8 | | | 2 | 0.8 |
| crystalline | | | | | | | | |
| 0115B (Zn ion | | | | | | | | |
| based) | | | | | | | | |
| Sirrus Forza | | | 2 | 0.8 | | | 2 | 0.8 |
| B4000 XP | | | | | | | | |
| Torque | | | 85 | | | | 0% | |
| Increase | | | | | | | | |

In study 1, the baseline torque is observed to be 10.2 N.m which dropped to around 9.4 N.m after the ionomer was added. In study 2, addition of Sirrus Forza B4000 XP (diethyl methylene malonate (DEMM) and butane diol with an average molecular weight between 1000-1500 daltons and an average functionality of 5) to the melt, results in an increase to 10.2 N.m, an 8.5% increase. A combination of study 3 and 4 showed no such increase. The initiation in PET is hypothesized to be Michael addition based through terminal OH groups on the main chains. The presence of OH groups may be much lower in the recycled grade of material compared to the virgin PET. Also, oxa Michael addition is inherently unstable at high temperatures. Therefore the formation and breaking of crosslinks or chain extension through oxa Michael addition may be an equilibrium process and may not result in a significant increase in the viscosity of the resultant melt. Again the contribution of the ionomer to initiate the methylene malonate and increase viscosity of the melt (240° C.) was marginal.

### Example 5: Twin Screw Extruder Trial Using Premium Recycled NYLON 6 Polyamide Mixed with Zinc Based Ionomer, Stabilizers and Methylene Malonate Macromer/Monomers

The trial is conducted using a Wellman Premium PCR Nylon 6 grade with the formulations In Table 5. The solid pelletized polymers are mixed separately and loaded in the hopper. The liquid Forza B4000 XP (diethyl methylene malonate (DEMM) and butane diol with an average molecular weight between 1000-1500 daltons and an average functionality of 5) was metered in using a peristatic pump in zone 4 of the twin screw extruder. The line was purged using nylene 200 between runs to minimize chances of contamination. Forza B4000 XP (diethyl methylene malonate (DEMM) and butane diol with an average molecular weight between 1000-1500 daltons and an average functionality of 5) was heated in a water bath maintained at 65° C., and pumped using a pre-calibrated peristatic pump to maintain an addition level of 1.1%. The pelletized formulations were injected molded into dogbone specimens to measure mechanical properties as shown in Table 6.

TABLE 5
Showing formulations for twin screw extruder using premium recycled
nylon 6 mixed with Zinc based ionomer, stabilizers and methylene
malonate macromer/monomers

| | Sirrus | | Control | | Mold only | |
|---|---|---|---|---|---|---|
| Components | % | pounds | % | pounds | % | pounds |
| Wellman Premium | 95.65 | 11.867 | 96.75 | 9.875 | 100 | 5 |
| PCR Nylon 6 | | | | | | |
| Standridge Color MB | 2 | 0.260 | 2 | 0.2 | | |
| 20842 (26% black in | | | | | | |
| nylon 6) | | | | | | |
| Apex Specialty | 1 | 0.126 | 1 | 0.1 | | |
| Crystallene 0226B (zn | | | | | | |
| based ionomer) | | | | | | |
| Addipel WPHSL | 0.25 | 0.03 | 0.25 | 0.025 | | |
| Sirrus Forza B4000 XP | 1.1 | 0.138 | | | | |

TABLE 6
Mechanical properties testing for the formulations outlined in Table 5.

| Property | Unit | Method | Sirrus | Control | Mold only |
|---|---|---|---|---|---|
| Density | g/cc | ISO 1183 | 1.15 | 1.15 | 1.15 |
| Mold Shrinkage | Mm | DIS 294-4 | 79.18 | 79.10 | 79.22 |
| (flow direction) | | | | | |
| Mold shrinkage | Mm | DIS 294-4 | 9.91 | 9.92 | 9.93 |
| (transflow | | | | | |
| direction) | | | | | |
| Mold Shrinkage | Mm | DIS 294-4 | 79.12 | 79.09 | 79.11 |
| (flow direction)- | | | | | |
| 24 hours | | | | | |
| Mold shrinkage | Mm | DIS 294-4 | 9.88 | 9.91 | 9.89 |
| (transflow | | | | | |
| direction)- | | | | | |
| 24 hours | | | | | |
| Tensile strength | MPa | ISO 527 | 66.49 | 55.94 | 60.24 |
| Elongation at | % | ISO 527 | 2.64 | 2.68 | 2.3 |
| break | | | | | |
| Tensile modulus | MPa | ISO 527 | 2.92 | 3.78 | 3.9 |
| Flexural strength | MPa | ISO 178 | 74.55 | 80.55 | 80.96 |
| Flexural | MPa | ISO 178 | 2403 | 2500 | 2617 |
| modulus | | | | | |
| Notched charpy | KJ/m2 | ISO 179 | 1.92 | 2.37 | 2.3 |
| HDT at 1.82 MPa | ° C. | ISO 75 | 51.1 | 57.2 | 53.6 |
| Spiral flow | inches | In house | 32.5 | 34.9 | 40.5 |

Addition of methylene malonate increases the tensile strength by 18.8%. However impact strength is lowered by almost 20% compared to the formulation containing the ionomer but no methylene malonate (control) as shown in Table 7. The tensile and flexural modulus also are reduced compared to the control. Viscosity of the system shows an increase while the heat deflection temperature is a reduction compared to the control. The appearance of the resultant plastic is a richer black color and dimensional stability of the molded part is excellent. Thus, methylene malonate can be an additive in applications requiring an increase in tensile strength of premium recycled polyamide material.

### Example 6: Twin Screw Extruder Trial Using Premium Recycled Nylon 6 Glass Filled Mixed with Zinc Based Ionomer, Stabilizers and Methylene Malonate Macromer/Monomers

The trial is conducted using a Wellman Premium PCR Nylon 6 grade filled with 30% glass fibers using the formulations described in Table 7. The solid pelletized polymers and glass fibers are mixed separately and loaded in the hopper. The liquid Forza B4000 XP (diethyl methylene malonate (DEMM) and butane diol with an average molecular weight between 1000-1500 daltons and an average functionality of 5) macromer is metered in using a peristatic pump in zone 4 of the twin screw extruder. The line is purged using nylene 200 between runs to minimize chances of contamination. Sirrus Forza B4000 XP (diethyl methylene malonate (DEMM) and butane diol with an average molecular weight between 1000-1500 daltons and an average functionality of 5) is heated up in a water bath maintained at 65° C. and pumped using a pre-calibrated peristatic pump to maintain an addition level of 1.1%. The pelletized formulations were injected molded into dogbone specimens to measure mechanical properties as shown in Table 8.

TABLE 7
Formulations for twin screw extruder using premium
recycled Nylon 6 polyamide glass filled mixed with
Zinc based ionomer, stabilizers and methylene
malonate macromer/monomers

| | Sirrus | | Control | |
|---|---|---|---|---|
| Components | % | pounds | % | pounds |
| Wellman Premium PCR | 66.75 | 8.22 | 67.75 | 6.675 |
| Nylon 6 | | | | |
| Standridge Color MB | 2 | 0.260 | 2 | 0.2 |
| 20842 (26% black in | | | | |
| Nylon 6) | | | | |
| Apex Specialty | 1 | 0.126 | 1 | 0.1 |
| Crystalline 0226B | | | | |
| (Zn based ionomer) | | | | |
| Addipel WPHSL | 0.25 | 0.03 | 0.25 | 0.025 |
| Sirrus Forza B4000 XP | 1.0 | 0.126 | | |
| John Manville GF | 30 | 3.76 | 30 | 3 |

TABLE 8
Mechanical properties testing for the formulations outlined in Table 7

| Property | Unit | Method | Sirrus | Control |
|---|---|---|---|---|
| Density | g/cc | ISO 1183 | 1.356 | 1.369 |
| Mold Shrinkage | Mm | DIS 294-4 | 79.88 | 79.80 |
| (flow direction) | | | | |
| Mold shrinkage | Mm | DIS 294-4 | 9.93 | 9.93 |
| (transflow | | | | |
| direction) | | | | |
| Mold Shrinkage | Mm | DIS 294-4 | 79.88 | 79.80 |
| (flow direction)- | | | | |
| 24 hours | | | | |
| Mold shrinkage | Mm | DIS 294-4 | 9.91 | 9.88 |
| (transflow | | | | |
| direction)- | | | | |
| 24 hours | | | | |
| Tensile strength | MPa | ISO 527 | 125.93 | 131.31 |
| Elongation at | % | ISO 527 | 2.43 | 2.37 |
| break | | | | |
| Tensile modulus | MPa | ISO 527 | 8.37 | 9.94 |
| Flexural strength | MPa | ISO 178 | 178.65 | 184.97 |
| Flexural modulus | MPa | ISO 178 | 6712.3 | 7168.25 |
| Notched charpy | KJ/m2 | ISO 179 | 3.29 | 2.92 |
| HDT at 1.82 MPa | ° C. | ISO 75 | 199.13 | 198.23 |
| Spiral flow | inches | In house | 19.75 | 23.2 |

Addition of methylene malonate reduces the tensile strength by 18.8%. However impact strength is increased by almost 13% compared to the formulation containing the ionomer but no methylene malonate (control). The tensile and flexural modulus also are reduced compared to the control. Viscosity of the system shows an increase while the heat deflection temperature is increases to 1° C. to the control. The appearance of the resultant plastic is a richer black color and dimensional stability of the molded part is excellent. Thus, methylene malonate can be an additive in applications requiring an increase in impact strength of premium recycled Nylon polyamide material that is glass filled.

### Example 7: Twin Screw Extruder Trial Using Virgin Nylon 6 Mixed with Zinc Based Ionomer, Stabilizers and Methylene Malonate Macromer/Monomers

The third trial was conducted using a BASF Ultramid 8202 HS virgin Nylon 6 grade using the formulations shown below in Table 9. The solid pelletized polymers were mixed separately and loaded in the hopper. The liquid Sirrus macromer was metered in using a peristatic pump in zone 4 of the twin screw extruder. Line was purged using nylene 200 between runs to minimize chances of contamination. Sirrus macromer was heated up in a water bath maintained at 65° C. and pumped using a pre-calibrated peristatic pump to maintain an addition level of 1.1%. The pelletized formulations were injected molded into dogbone specimens to measure mechanical properties as shown in Table 10.

TABLE 9
Showing formulations for twin screw extruder using virgin
Nylon 6 polymer mixed with Zinc based ionomer,
stabilizers and methylene malonate macromer/monomers

| | Sirrus | | Control | |
|---|---|---|---|---|
| Components | % | pounds | % | pounds |
| BASF Ultramid 8202 | 95.65 | 11.957 | 100 | 5 |
| HS | | | | |
| Standridge Color MB | 2 | 0.250 | | |
| 20842 (26% black in | | | | |
| nylon 6) | | | | |
| Apex Specialty | 1 | 0.125 | | |
| Crystallene 0226B | | | | |
| (zn based ionomer) | | | | |
| Addipel WPHSL | 0.25 | 0.03 | | |
| Sirrus Forza B4000 XP | 1.1 | 0.138 | | |

TABLE 10
Mechanical properties testing for the formulations outlined in Table 9

| Property | Unit | Method | Sirrus | Mold only |
|---|---|---|---|---|
| Density | g/cc | ISO 1183 | 1.14 | 1.13 |
| Mold Shrinkage | Mm | DIS 294-4 | 79.27 | 79.23 |
| (flow direction) | | | | |
| Mold shrinkage | Mm | DIS 294-4 | 9.91 | 9.92 |
| (transflow | | | | |
| direction) | | | | |
| Mold Shrinkage | Mm | DIS 294-4 | 79.16 | 79.11 |
| (flow direction)-24 | | | | |
| hours | | | | |
| Mold shrinkage | Mm | DIS 294-4 | 9.88 | 9.90 |
| (transflow | | | | |
| direction)-24 | | | | |
| hours | | | | |
| Tensile strength | MPa | ISO 527 | 73.76 | 77.46 |
| Elongation at | % | ISO 527 | 9.54 | 6.20 |
| break | | | | |
| Tensile modulus | MPa | ISO 527 | 2.95 | 3.36 |
| Flexural strength | MPa | ISO 178 | 72.52 | 77.22 |
| Flexural modulus | MPa | ISO 178 | 2274.4 | 2452 |
| Notched charpy | KJ/m2 | ISO 179 | 2.86 | 2.44 |
| HDT at 1.82 MPa | ° C. | ISO 75 | 52.6 | 52.0 |
| Spiral flow | inches | In house | 29.75 | 28.1 |

Addition of methylene malonate reduced the tensile strength by 5%. However impact strength increased by almost 17% compared to the mold only formulation with no methylene malonate (control) and elongation at break increased by almost 50%. The tensile and flexural modulus showed a reduction compared to the control. Viscosity of the system shows an increase while the heat deflection temperature was maintained compared to the control. This confirms that in case of virgin nylon polyamide grades, enough anionic functionality exists on the main chain to promote initiation of the methylene malonate additives and they enhance the characteristics of the resultant polymer and do not self-polymerize and plasticize. The appearance of the resultant plastic is a richer black color and dimensional stability of the molded part is excellent. Thus, methylene malonate can be an additive in applications requiring an increase in impact strength of virgin nylon 6 nylon material.

What is claimed is:

1. A method of forming a copolymer comprising:
heating a polymer having a nucleophilic group and mixing a 1,1-disubstituted alkene therewith at a temperature sufficient to form the copolymer, wherein at least a portion of the 1,1-disubstituted alkene bonds to and chain extends, cross-links or combination thereof the polymer having nucleophilic groups.

2. The method of claim 1, wherein at least a portion of the 1,1-disubstituted alkene homopolymerizes.

3. The method of claim 1, wherein the 1,1-disubstituted alkene is comprised of a monofunctional 1,1-disubstituted alkene and multifunctional 1,1-disubstituted alkene.

4. The composition of claim 3, wherein the multifunctional 1,1-disubstituted alkene is present in an amount of about 5% to 33% by weight of the 1,1-disubstituted alkene.

5. The method of claim 1, wherein the polymer having the nucleophilic group is a condensation polymer.

6. The method of claim 1, wherein the nucleophilic group is a carboxylic acid, carboxylate, alcohol, phenol, amine, aniline, imidazole, tetrazole, thiol, boronic acid, boronic acid salts, glycol, hydrazine, hydroxyl amine group or combinations thereof.

7. The method of claim 1, wherein the polymer having a nucleophilic group is comprised of an ionomer.

8. The method of claim 1 wherein the polymer having a nucleophilic group is a polyamide, polyglycol or polyethylene terephthalate.

9. The method of claim 7, wherein the ionomer is present in an amount of about 1% to 10% by weight of the polymer having the nucleophilic group.

10. The method of claim 7, wherein the ionomer is comprised of a lithium carboxylate, a magnesium carboxylate a zinc carboxylate or combinations thereof.

11. The method of claim 1, wherein the nucleophilic group is an amine, a salt thereof, a carboxyl group, a salt thereof or an alcohol.

12. The method of claim 1, wherein the polymer having the nucleophilic group is a nylon polymer, a glycol polymer or a polyester polymer.

13. The method of claim 1, wherein the 1.1-disubstituted alkene is supported on a solid carrier.

14. The method of claim 1, wherein the polymer having a nucleophilic group is comprised of recycled polymer.

15. The method of claim 14, wherein the recycled polymer is present in an amount of at least 50% by weight of the polymer having a nucleophilic group.

16. A copolymer comprised of the reaction product of a polymer having a nucleophilic group and a 1,1-disubstituted alkene.

17. The copolymer of claim 16, wherein the 1,1-disubstituted alkene is comprised of a monofunctional 1,1-disubstituted alkene and a multifunctional 1,1-disubstituted alkene.

18. The copolymer of claim 16, wherein the 1,1-disubstituted alkene residue is present in an amount of about 1% to 10% by weight of the copolymer.

19. The copolymer of claim 16, wherein the polymer having the nucleophilic group is a condensation polymer, ionomer or mixture thereof.

20. The copolymer of claim 16, wherein the polymer having the nucleophilic group is a recycled polymer comprised at least one of: a polyamide, polyester or polyglycol.
